(19) United States
(12) Patent Application Publication
(10) Pub. No.: US 2012/0152148 A1
(43) Pub. Date: Jun. 21, 2012

(54) NON-BUFFING WAX EMULSION COMPOSITION

(75) Inventors: Colin Dilley, Thomaston, CT (US); Joseph K. Mathews, New Milford, CT (US)

(73) Assignee: HONEYWELL INTERNATIONAL INC., Morristown, NJ (US)

(21) Appl. No.: 12/974,487

(22) Filed: Dec. 21, 2010

(51) Int. Cl. C09G 1/10

(52) U.S. Cl. 106/5

(57) ABSTRACT

Disclosed herein is a composition comprising a formula emulsion wherein the formula emulsion comprises a cationic or amphoteric surfactant, a wax emulsion, a thickener, and at least two silicone oils having different viscosities, wherein the composition is free of abrasives and organic solvents. The weighted average viscosity of the silicone oils is 2200 to 2400 centistokes (cSt).

### BACKGROUND

It is desirable to keep many exposed surfaces, such as the surfaces of vehicles, clean for reasons such as maintaining the appearance of the surface, minimizing surface tarnishing, reducing paint wear and fading if the surface is painted, and preventing corrosion on the surface. It is well known that regular waxing of a vehicle can assist in maintaining the appearance of the vehicle and extend its useful life.

There is a vast array of waxes and polishes commercially available that are intended for use on many surfaces, including vehicles. Polishes clean paint finishes and remove oxidation and other contaminants by using abrasives, while waxes protect paint finishes. Many waxes can perform a suitable job of imparting a glossy or shiny finish to a surface when used properly.

Most vehicle wax compositions require a two-step application process. The first step is applying the wax composition to the vehicle surface and allowing the wax to dry. The second step involves vigorous buffing to smooth the wax that adhered to the surface, while wiping away any excess wax that did not adhere. Generally, the best protection of vehicle surfaces occurs with a maximum thickness of wax bonded to a surface. In order to increase bonding strength, advanced wax compositions are being formulated to include chemical bonding agents to enhance adhesion to a surface.

U.S. Pat. No. 5,330,787 discloses a no buffing polish composition for a surface of a vehicle comprising a cationic surfactant, dialkyl silicone, aminofunctional silicone, thickener, wax, and water. However, the composition disclosed in U.S. Pat. No. 5,330,787 dries quickly, and leaves a film that is difficult to remove.

Thus users desire the following improvements in a wax composition: (1) strong adhesion of wax particles to a surface, while eliminating the arduous buffing task that is needed to smooth conventional wax films formed on a surface; (2) allowing any remaining residue to be removed from the surface without wiping; and (3) superior durability, water resistance, and glossiness of the wax film.

### BRIEF DESCRIPTION OF THE INVENTION

Surprisingly we have discovered a wax composition that provides superior durability, water resistance, and glossiness, while eliminating the arduous buffing task that is needed to smooth conventional wax films. The composition comprises a formula emulsion wherein the formula emulsion comprises a cationic or amphoteric surfactant, a wax emulsion, a thickener, and at least two silicone oils having different viscosities, wherein the composition is free of abrasives and organic solvents. The weighted average viscosity of the silicone oils is 2200 to 2400 centistokes (cSt).

### DETAILED DESCRIPTION

The wax composition described above surprisingly can be applied and achieve a high gloss without a separate buffing step and excess wax can be rinsed off with water. Without being bound by theory it is believed that upon contact with a surface, the formula emulsion breaks so as to allow the wax to contact the surface and form a film. In the film, the nonpolar wax particles adhere to the surface forming a wax layer, while the surfactant and silicone oils move away from the deposited wax particles and to the surface of the film, where removal of the surfactant and some of the silicone oils with water buffs the surface of the wax layer. The remaining emulsion is easily removed by water spray at the silicone surfactant interface. The remaining silicones and wax help dry the car by creating a hydrophobic surface which repels water from the surface.

The term “hose-away” is employed herein to denote that following an application of a wax composition that forms a film over a surface, water can then be sprayed over the film to remove any excess emulsion and to impart a glossy finish without the need for a vigorous hand applied buffing step of conventional wax formulations. The term “break” or “breaking” are terms applied to the irreversible coalescence of the individual ingredients of an emulsion to form a continuous phase on a surface. To break an emulsion, the stabilizing forces of the emulsion are weakened or overcome by opposing forces that attract certain ingredients of the emulsion.

The dried wax layer described herein obviates the need for strenuous buffing by correlating the effective amounts of ingredients of the wax composition so as to provide a dry, hydrophobic layer adhering to a surface, and coalescing of excess composition at the surface of the hydrophilic film, which may be removed by rinsing with water. The hydrophobic nature of the surface is readily ascertained by observing the water beading characteristics over the dried wax layer of the surface. The smoothness of the wax layer is readily ascertained by observing the glossiness of the wax film as the film dries and hardens.

The surfactant can be a cationic or amphoteric surfactant. The surfactant assists to provide a formula emulsion (wax and silicone oils in water) that is on the edge of stability. Application of the composition by hand breaks the emulsion by shearing it, depositing the wax to the surface in an even layer, and leaving a silicone layer on the wax. Formula stability is provided by the thickener. On rinsing the formula is diluted and the thickener is no longer able to hold the emulsion together (it is diluted) and the emulsion breaks and rinses away the remaining formula.

Cationic surfactants include fatty acid amines, amides, and their salts. Cationic surfactants are exemplified by aliphatic fatty amines and their derivatives such as dodecylamine acetate, octadecylamine acetate, and acetates of the amines of tallow fatty acids; homologues of aromatic amines having fatty chains such as dodecylaniline; fatty amides derived from aliphatic diamines such as undecyl imidazoline; fatty amides derived from di-substituted amines such as oleyl aminodiethylamine; derivatives of ethylene diamine; quaternary ammonium compounds such as tallow trimethyl ammonium chloride, dioctadecyl dimethyl ammonium chloride, didodecyl dimethyl ammonium chloride and dihexadecyl dimethyl ammonium chloride; amide derivatives of amino alcohols such as beta-hydroxyethyl stearylamide; amine salts of long chain fatty acids; quaternary ammonium bases derived from fatty amides of di-substituted diamines such as oleylbenzyl aminoethylene diethylamine hydrochloride; quaternary ammonium bases of benzimidazolines such as methylheptadecyl benzimidazol hydrobromide; basic compounds of pyridinium and its derivatives such as cetyl pyridinium chloride; sulfonium compounds such as octadecyl sulfonium methyl sulfate; quaternary ammonium compounds of betaine such as betaine compounds of diethylamino acetic acid and octadecyl chloromethyl ether; urethanes of ethylene diamine such as condensation products of stearic acid and diethylene triamine; polyethylene diamines; and polypropanol polyethanol amines.

Examples of commercial cationic surfactants are those products sold under the tradenames Maquat OAC, an 80% active oleyl dimethylbenzyl ammonium chloride from Mason Chemical, Colasolve OES, an oleyl ethylimidazolinium ethosulfate from Colonial Chemical, ARQUAD T-27 W, ARQUAD 16-29 W, ARQUAD C-33 W, ARQUAD T-50, and ETHOQUAD T-13-27 W ACETATE by Akzo Chemicals, Inc., Chicago, Ill. Further examples of such cationic surfactants are ARQUAD 2C-75 and VARIQUAT K-300. Both contain about 75 weight percent dicoco alkyldimethyl quaternary ammonium chloride and are amber liquids having a specific gravity of about 0.885 (25° C.).

The amphoteric surfactants can include, for example, a betaine such as carboxyl betaine and sulfobetaine, an aminocarboxylic acid, and imidazoline derivatives. Preferred are imidazoline derivatives.

The surfactants can be used singly or in combination with the other surfactant and surfactants.

The surfactant can be present in an amount of 0.5 to 20 weight percent based on the total weight of the composition. Within this range, the surfactant can be present in an amount greater than or equal to 2 weight percent, or more specifically greater than or equal to 5 weight percent. Also, within this range, the surfactant can be present in an amount less than or equal to 15 weight percent, or more specifically, an amount less than or equal to 10 weight percent.

The wax emulsion can comprise waxes such as petronauba, carnauba, paraffin, duroxon, Wax S and Wax E. Wax S and Wax E are available from Hoechst Celanese Corporation, Somerville, N.J. A carnauba wax emulsion, such as Michem® Emulsion 62125 AM, available through Michelman, Inc., is useful herein and is characterized as an anionic carnauba wax emulsion having a specific gravity of 0.98-1.00, a dark brown color, and a pH of about 8.5-9.5.

The wax emulsion can also comprise emulsified vegetable wax such as haze wax, candelilla wax and rice wax; animal wax such as bees wax, insect wax, shellac wax and whale wax; and mineral wax such as montan wax, ozocerite and ceresine.

The wax emulsion can be present in an amount of 0.1 to 40 weight percent based on the total weight of the composition. Within this range, the wax can be present in an amount greater than or equal to 2 weight percent, or more specifically greater than or equal to 5 weight percent. Also, within this range, the wax can be present in an amount less than or equal to 25 weight percent, or more specifically, an amount less than or equal to 15 weight percent. The wax emulsion can have a solids content of 20 to 30 weight percent based on the total weight of the wax emulsion.

As used herein, the term “silicone”, “polysiloxane”, and grammatical variations thereof means a polymer having the general formula (RₙSiO_{((4-n)/2)})ₘ wherein n is between 0 and 3 and m is 2 or greater. Typically, the value of m is about 1-1,250. Silicones can be linear or branched. As used herein, the terms “silicone”, “silicone oil” and “polysiloxane” are equivalent.

Illustrative silicones include polydimethylsiloxane, polydiethylsiloxane, polymethylethylsiloxane, polymethylphenylsiloxane, and polydiphenylsiloxane. By polydimethylsiloxane (PDMS), we mean a polysiloxane having the above formula where n is two and R is a methyl radical. Preferred silicones are polydimethylsiloxanes. Useful silicone oils are commercially available from a variety of manufacturers such as Momentive Performance Materials of Albany, N.Y. and Dow Corning Corporation of Midland, Mich.

There are at least two silicone oils present in the composition. Each silicone oil has a different viscosity. The viscosities for each silicone oil can be 50 to 100,000 cSt. The weighted average silicone oil viscosity is 2200 to 2400 cSt. The weighted average is determined by multiplying the amount of each oil (in weight percent based on the total quantity of silicone oil) by the viscosity of that same oil and summing the values.

The combined amount of silicone oils can be 5 to 15 weight percent, based on the total weight of the composition. Within this range the combined amount of silicone oils can be greater than or equal to 7 weight percent. Also within this range the combined amount of silicone oils can be less than or equal to 12 weight percent. The different silicone oils can be present individually in equal amounts or differing amounts. In one embodiment each silicone oil is present in the same amount.

In order to adjust the viscosity of the wax composition for application to a surface, the wax composition can include a thickener. Such thickeners should be non-abrasive, nonionic, not dry to an unremovable film, and environmentally friendly. Examples of thickeners that can be used include: cellulose-based thickeners, such as for example hydroxyethylcellulose, methylcellulose, hydroxypropylcellulose and carboxymethylcellulose. Among these thickeners, a preferred example includes the gum sold under the name “CELLOSIZE QP 5200H” products, which is water-soluble polymers that thicken, form films, exhibits pseudoplastic solution behavior, tolerate salts, and retains water.

The thickener can be present in an amount of 0.01 to 5 weight percent based on the total weight of the composition. Within this range, the thickener can be present in an amount greater than or equal to 0.1 weight percent, or more specifically greater than or equal to 0.5 weight percent. Also, within this range, the thickener can be present in an amount less than or equal to 3 weight percent, or more specifically, an amount less than or equal to 2 weight percent.

In addition to the other ingredients of the wax composition, the composition comprises water. The composition may further comprise an alcohol such as 2-butoxy ethanol. Water can be present in an amount of 40 to 95 weight percent based on the total weight of the composition. Within this range, water can be present in an amount greater than or equal to 60 weight percent, or more specifically greater than or equal to 70 weight percent. Also, within this range, water can be present in an amount less than or equal to 85 weight percent, or more specifically, an amount less than or equal to 80 weight percent.

The compositions may also contain other optional ingredients such as dyes, fragrances, UV absorbers, gloss enhancers, anti-foam agents, corrosion inhibitors, soil repellents, and other known ingredients of wax compositions; provided that the beneficial attributes of the composition is maintained by use of such additional ingredients.

In one embodiment the composition comprises a formula emulsion wherein the formula emulsion comprises a 0.5 to 20 weight percent of a cationic surfactant, 0.1 to 40 weight percent of a carnauba wax emulsion, 0.01 to 5 weight percent of a cellulose-based thickener, 2 to 4 weight percent of a silicone oil having a viscosity of 300 to 400 centistokes, 2 to 4 weight percent of a silicone oil having a viscosity of 50 to 150 centistokes, 2 to 4 weight percent of a silicone oil having a viscosity of 900 to 1100 centistokes, and 0.250 to 0.750 weight percent of a silicone oil having a viscosity of 10,000 centistokes, wherein weight percent is based on the total weight of the composition, the composition is free of abrasives and organic solvents and the weighted average viscosity of the silicone oils is 2200 to 2400 centistokes.

According to one embodiment, the wax composition can be prepared by first mixing water and ammonium hydroxide. This mixture is then combined with the thickener. A surfactant is added next, followed by the addition of the silicone oils. This results in an emulsion. The wax emulsion is added next, followed by fragrance and biocide. It is noted that fragrance and biocide may be added at any time in the process and do not need to be added last. It is desirable to mix at medium shear with minimal introduction of air.

The wax composition may have a final pH of about 7 to about 9, preferably about 7.5 to about 8.5. The wax composition may have a final viscosity of 9500 to 12000 cSt.

The wax composition can be applied to a clean exterior surface. The surface can be wet or dry. The wax composition is preferably applied to a pre-wetted exterior surface with a pre-wetted cloth, sponge, or mitt.

The composition is rubbed onto the exterior surface, preferably in a circular motion. After the surface has been coated with the wax composition it is rinsed with a sufficient quantity of water to remove formed film and substantially all of the excess residue from the surface. It is preferable to rinse off before the surface is substantially dry. The automotive surface can be towel dried after rinsing. A uniform, durable, high-gloss, water resistant, protective film is thus obtained, without the need for buffing or additional wiping away of excess polish as is generally required with conventional car wax products.

This process provides several advantages over prior art waxing processes. First, when a typical wax product is applied to surface such to a surface such as an automobile, the applier will normally apply some wax in the cracks and abutting areas of the hood, doors and other parts. The excess dried wax film is removed by buffing the dried film with a cloth. The excess dried wax film tends to lodge in cracks and abutting areas on the automobile surfaces as it is buffed loose from the painted surface of the automobile. The wax composition described herein overcomes the excess dried wax problem by providing a wax composition that does not require buffing in order to form a glossy dried wax film, and while allowing any excess not adhering to the surface to be simply “hosed-away”. In addition, this new application/removal process is substantially faster, since the time for application and removal are substantially decreased by faster removal of any excess wax composition. Further, when applied as a paste or liquid the instant wax emulsion provides a cleaning action for the surface being polished. After washing the car need not be dried, the wax can be applied to the wet surface, thus saving time

It has been found that by correlating the effective amounts of critical ingredients in the polish compositions of this invention that novel spray-away polish compositions can be formed.

The wax emulsion composition and process is further demonstrated by the following non-limiting examples.

### Examples 1-3

### Example 1

| | Weight | |
|---|---|---|
| Ingredient | Percent | Description |
| Water | 72.609 | |
| Aqua Ammonia | 0.003 | Aqueous ammonium hydroxide. |
| Cellosize QP 5200H | 0.938 | Thickener commercially available |
| | | from Dow Chemical. |
| Arquad 2C-75 | 6.700 | Cationic surfactant commercially |
| | | available from Akzo Nobel. |
| Silicone Oil 350 cSt | 3.00 | Polydimethylsiloxane |
| Silicone Oil 1000 cSt | 3.00 | Polydimethylsiloxane |
| Silicone Oil 100 cSt | 3.00 | Polydimethylsiloxane |
| Silicone Oil 10,000 cSt | 0.500 | Polydimethylsiloxane |
| ME62125AM | 10.00 | Anionic carnauba wax emulsion |
| | | commercially available from |
| | | Michelman, Inc. |
| Pina Colada #280-363 | 0.200 | Fragrance |
| Nipacide Bit 20 | 0.050 | Biocide commercially available |
| | | from Clariant, Inc. |

### Example 2

| | Weight | |
|---|---|---|
| Ingredient | Percent | Description |
| Water | 72.609 | |
| Aqua Ammonia | 0.003 | Aqueous ammonium hydroxide |
| Cellosize QP 5200H | 0.938 | Thickener commercially available |
| | | from Dow Chemical. |
| Maquat OAC | 3.00 | Cationic surfactant commercially |
| | | available from Mason Chemical |
| Silicone Oil 350 cSt | 3.00 | Polydimethylsiloxane |
| Silicone Oil 1000 cSt | 3.00 | Polydimethylsiloxane |
| Silicone Oil 100 cSt | 3.00 | Polydimethylsiloxane |
| Silicone Oil 10,000 cSt | 0.500 | Polydimethylsiloxane |
| ME62125AM | 10.00 | Anionic carnauba wax emulsion |
| | | commercially available from |
| | | Michelman, Inc. |
| Pina Colada #280-363 | 0.200 | Fragrance |
| Nipacide Bit 20 | 0.050 | Biocide commercially available |
| | | from Clariant, Inc. |

### Example 3

| | Weight | |
|---|---|---|
| Ingredient | Percent | Description |
| Water | 72.609 | |
| Aqua Ammonia | 0.003 | Aqueous ammonium hydroxide |
| Cellosize QP 5200H | 0.938 | Thickener commercially available |
| | | from Dow Chemical. |
| Cola Solv OES | 2-2.5 | Cationic surfactant commercially |
| | | available from Colonial Chemical |
| Silicone Oil 350 cSt | 3.00 | Polydimethylsiloxane |
| Silicone Oil 1000 cSt | 3.00 | Polydimethylsiloxane |
| Silicone Oil 100 cSt | 3.00 | Polydimethylsiloxane |
| Silicone Oil 10,000 cSt | 0.500 | Polydimethylsiloxane |
| ME62125AM | 10.00 | Anionic carnauba wax emulsion |
| | | commercially available from |
| | | Michelman, Inc. |
| Pina Colada #280-363 | 0.200 | Fragrance |
| Nipacide Bit 20 | 0.050 | Biocide commercially available |
| | | from Clariant, Inc. |

Examples 1-3 were prepared by mixing water and ammonium hydroxide. This mixture was then combined with the thickener. The surfactant was added next, followed by the addition of the silicone oils. This resulted in an emulsion. The wax emulsion was added next, followed by fragrance and biocide. The ingredients were mixed at medium shear for 15 minutes with minimal introduction of air.

### Comparative Example 1

| | Weight | |
|---|---|---|
| Ingredient | Percent | Description |
| Water | 72.8775 | |
| Aqua Ammonia | 0.003 | Aqueous ammonium hydroxide |
| Bentone LT | 1.25 | Thickener commercially available |
| | | from Elementis Specialties. |
| Glacial Acetic Acid | 0.200 | |
| Arquad 2C-75 | 6.700 | Cationic surfactant commercially |
| | | available from Akzo Nobel. |
| Isopropanol | 0.320 | |
| 2-butoxy ethanol | 3.00 | |
| Silicone Oil 350 cSt | 4.50 | Polydimethylsiloxane |
| (dialkypolysiloxane) | | |
| Co-wax emulsion | 10.00 | Anionic carnauba wax emulsion |
| | | commercially available from |
| | | Michelman, Inc. |
| Amino functional silicone | 1.00 | |
| Fragrance | 0.200 | Fragrance |

Comparative Example 1 was prepared by mixing water and ammonium hydroxide. This mixture was then combined with the thickener. The mixture became very clumpy and required a significant amount of time to even out. The glacial acetic acid was then added followed by the surfactant. Mixing continued to achieve even dispersal. Isopropanol and 2-butoxy ethanol were added next, followed by the addition of the silicone oil. The wax emulsion was added next, followed by the amino functional silicone. Finally fragrance and biocide were added. The ingredients were mixed at medium shear for 15 minutes with minimal introduction of air.

Testing began with a rinse off test—the formulations were applied to a paint panel and rinsed using a spray of water either from the sink faucet or a spray bottle. Observations were noted. Products were subject to a paint compatibility test which showed if formulations would harm or cause damage a painted surface. If an example caused no harm it was evalutated on a vehicle painted surface. Once the products were applied they were rinsed off using a garden hose with a forceful spray of water. Observations were again noted. The comparative example did not rinse off completely and residue on the paint in the initial rinse off test making further testing unnecessary for the comparative example. The inventive examples all demonstrated full rinse off, good paint compatibility and a glossy finish.

The singular forms “a,” “an,” and “the” include plural referents unless the context clearly dictates otherwise. The endpoints of all ranges reciting the same characteristic or ingredient are independently combinable and inclusive of the recited endpoint. All references are incorporated herein by reference. The terms “first,” “second,” and the like herein do not denote any order, quantity, or importance, but rather are used to distinguish one element from another. The various embodiments and ranges described herein are combinable to the extent that the description is not contradictory.

While typical embodiments have been set forth for the purpose of illustration, the foregoing descriptions should not be deemed to be a limitation on the scope herein. Accordingly, various modifications, adaptations, and alternatives may occur to one skilled in the art without departing from the spirit and scope herein.

1. A composition comprising a formula emulsion wherein the formula emulsion comprises a cationic or amphoteric surfactant, a wax emulsion, a thickener, at least two silicone oils having different viscosities, wherein the composition is free of abrasives and organic solvents and the weighted average viscosity of the silicone oils is 2200 to 2400 centistokes.

2. The composition of claim 1, wherein the surfactant is a cationic surfactant.

3. The composition of claim 1, wherein the surfactant is present in an amount of 0.5 to 20 weight percent based on the total weight of the composition.

4. The composition of claim 1, wherein the wax emulsion comprises carnauba wax.

5. The composition of claim 1, wherein the wax emulsion is present in an amount of 0.1 to 40 weight percent based on the total weight of the composition.

6. The composition of claim 1, wherein the silicone oils each have a viscosity of 50 centistokes to about 100,000 centistokes.

7. The composition of claim 1, wherein the combined amount of silicone oils is 5 to 15 weight percent based on the total weight of the composition.

8. The composition of claim 1, wherein the silicone oils are present in equal amounts.

9. The composition of claim 1, wherein the thickener comprises a cellulose-based thickener.

10. The composition of claim 9, wherein the thickener is present in an amount of 0.01 to 5 percent based on the total weight of the composition.

11. The composition of claim 1, wherein the pH is about 7 to about 9.

12. The composition of claim 1, wherein the composition has a viscosity of 9500 to 12000 cSt.

13. A composition comprising a formula emulsion wherein the formula emulsion comprises a 0.5 to 20 weight percent of a cationic surfactant, 0.1 to 40 weight percent of a carnauba wax emulsion, 0.01 to 5 weight percent of a cellulose-based thickener, 2 to 4 weight percent of a silicone oil having a viscosity of 300 to 400 centistokes, 2 to 4 weight percent of a silicone oil having a viscosity of 50 to 150 centistokes, 2 to 4 weight percent of a silicone oil having a viscosity of 900 to 1100 centistokes, and 0.250 to 0.750 weight percent of a silicone oil having a viscosity of 10,000 centistokes, wherein weight percent is based on the total weight of the composition, the composition is free of abrasives and organic solvents and the weighted average viscosity of the silicone oils is 2200 to 2400 centistokes.
